(19) United States
(12) Patent Application Publication
(10) Pub. No.: US 2026/0229396 A1
(43) Pub. Date: Aug. 6, 2026

(54) COIL COMPONENT, AND ELECTRONIC AND ELECTRIC APPARATUS

(71) Applicant: DELTA ELECTRONICS (JAPAN), INC., Tokyo (JP)

(72) Inventors: Taishi NUMATA, TOKYO (JP); Yamato SAKURAI, TOKYO (JP); Kenichi IKEDA, TOKYO (JP); Keiichi ARAKI, TOKYO (JP)

(73) Assignee: DELTA ELECTRONICS (JAPAN), INC., Tokyo (JP)

(21) Appl. No.: 19/150,921

(22) PCT Filed: Dec. 19, 2023
(86) PCT No.: PCT/JP2023/045450

§ 371 Date: Sep. 10, 2025

(30) Foreign Application Priority Data
Jan. 26, 2023 (WO) PCT/JP2023/002528

(51) Int. Cl. H01F 27/28; H01F 27/29

(52) U.S. Cl. CPC H01F 27/2804; H01F 27/292; H01F 2027/2809

(57) ABSTRACT

A coil component exhibits an excellent overall characteristic when used as an inductance element. The coil component includes first and second coil conductors aligned in a first direction, each of which has a first spiral portion moving around an axis extending along the first direction and away from the axis; a via member electrically connecting the first coil conductor and the second coil conductor; a first terminal member electrically connected to the first coil conductor; and a second terminal member electrically connected to the second coil conductor. The first spiral portion has a first high winding part, and a first low winding part having a number of turns less than that of the first high winding part. A turn in the first low winding part has a portion having a turn width greater than that of a turn in the first high winding part when viewed in the first direction.

### BACKGROUND OF THE INVENTION

### 1. Field of the Invention

The present invention relates to a coil component, and an electronic/electric device, in which the coil component is installed.

### 2. Description of the Related Art

In Patent Document 1, a multilayer seed pattern inductor, which includes a magnetic body and an internal coil portion, is disclosed. In the coil conductor portion of the internal coil portion of the inductor, the coil width is kept constant.

In Patent Document 2, a coil component including an insulating substrate, a coil, a resin wall, and a magnetic base body is disclosed. In the coil component, there is a non-overlapping region where the innermost turn of a first coil conductor pattern on one side of the insulating substrate and the innermost turn of a second coil conductor pattern on the other side of the insulating substrate do not overlap with each other in the thickness direction of the insulating substrate. The sum of the width of the innermost turn of the first coil conductor pattern in this non-overlapping region and the width of the resin wall located inside this innermost turn is narrower than the sum of the width of the turn outer than the innermost turn of the first coil conductor pattern and the width of the resin wall located inside this turn.

### PRIOR ART DOCUMENTS

### Patent Documents

[Patent Document 1] Japanese Patent Publication No. 2016-213443
[Patent Document 1] Japanese Patent Publication No. 2019-16745

### SUMMARY OF THE INVENTION

### Problems to be Solved by the Invention

The inductance value of the coil component disclosed in Patent Document 2 is improved by reducing the dead space in the non-overlapping region of the inductor disclosed in Patent Document 1. In particular, in Patent Document 2, the inductance value is to be improved by narrowing the width of the conductor located in the non-overlapping region. However, resistance would increase in the portion where the conductor width is narrowed. Therefore, as an inductance element, its direct current resistance DCR largely increases. As a result, the coil component disclosed in Patent Document 2, as an inductance element, has a problem of lowered overall characteristic L×Isat/DCR, where L is self-inductance, Isat is direct-current superposition rated current, and DCR is direct-current resistance. In addition, in the first turn of the conductor, the width of the conductor gradually increases toward the second turn of the conductor, and the width of the coil is kept constant from the second turn. Thus, due to the concern in the prior art about the decrease in inductance value resulting from the decrease in magnetic material, it is desirable that the width of the conductor is kept constant by avoiding abrupt or local increase in the width of the conductor, as disclosed in Patent Document 1 and Patent Document 2.

An object of the present invention is to provide a coil component, which has a spiral-type conductor and has an excellent overall characteristic as an inductance element. In addition, another object of the present invention is to provide an electronic/electric device, which is installed therein a coil component.

### Means to Solve the Problems

For solving the above problems, according to the research of the inventors, in Patent Document 2, the magnetic properties are improved by narrowing the width of the turns of the coil conductor located in the non-overlapping region. However, narrowing the width of the turns leads to an increase in resistance in that area, which is a cause of reduced overall characteristic L×Isat/DCR of the inductance element. Therefore, new findings show that L×Isat/DCR can be increased by reducing the non-overlapping region, and ideally not allowing the non-overlapping region to exist at first.

An aspect of the present invention, which is contemplated based on such findings, is a coil component. The coil component includes a first coil conductor portion including a first spiral portion, which is shaped as a spiral extending from a first inner-side end part toward a first outer-side end part around an axis in a first direction and moving away from the axis; a second coil conductor portion including a second spiral portion, which is shaped as a spiral extending from a second inner-side end part toward a second outer-side end part around the axis oppositely relative to the first spiral portion and moving away from the axis, and aligned with the first coil conductor portion in the first direction; a via member electrically connected to the first inner-side end part and the second inner-side end part; a first terminal member electrically connected to the first outer-side end part; and a second terminal member electrically connected to the second outer-side end part. The first spiral portion includes a first high winding portion and a first low winding portion with a less turn number compared with the first high winding portion, and a turn disposed in the first low winding portion includes a portion having a turn width, when viewed in the first direction, greater than that of a turn disposed in the first high winding portion.

In a coil, in which two conductors are wound as a spiral shape in opposite directions when viewed from the first direction, and overlap in the first direction, portions with different numbers of turns may exist. In a case that the cross-sectional shapes of the wound conductors are the same, the width of the coil conductor portion as viewed in the winding axis direction is narrower in the portion with a relatively small number of turns (low winding portion). Therefore, by relatively increasing the cross-sectional area of the conductor located in the low winding portion, it is possible to reduce the resistance of the coil conductor portion. As a result, it is possible to improve the overall characteristic (L×Isat/DCR) when used as an inductance element.

In the coil component, the second coil conductor portion includes a second opposing portion, which is disposed opposite to the first low winding portion in the first direction, and at least respective inner circumferences or respective outer circumferences of the second opposing portion and the first low winding portion may have overlapping portions in the first direction.

In the coil component, the first low winding portion and the second opposing portion may have equal-width portions in the first direction.

In the coil component, the second spiral portion includes a second high winding portion and a second low winding portion with a less turn number compared with the second high winding portion, and a turn disposed in the second low winding portion may include a portion having a turn width, when viewed in the first direction, greater than that of a turn disposed in the second high winding portion.

In this case, the first coil conductor portion includes a first opposing portion, which is disposed opposite to the second low winding portion in the first direction, and at least respective inner circumferences or respective outer circumferences of the first opposing portion and the second low winding portion may have overlapping portions in the first direction.

In the above case, the second low winding portion and the first opposing portion may have equal-width portions in the first direction.

In the coil component, an insulating coil insulator portion may be disposed between the first spiral portion and the second spiral portion.

In the coil component, when viewed in the first direction, the following conditions may be satisfied: an inner circumference of the first coil conductor portion coincides with an inner circumference of the second coil conductor portion from a distal end part in a portion of the first coil conductor portion, which is opposite to the first inner-side end part with a gap clamped in between, to a portion overlapping a distal end part in a portion of the second coil conductor portion, which is opposite to the second inner-side end part with a gap clamped in between; an outer circumference of the first coil conductor portion coincides with an outer circumference of the second coil conductor portion from a portion overlapping a portion in connection with the second outer-side end part to a portion in connection with the first outer-side end part; and the outer circumference of the first coil conductor portion coincides with the outer circumference of the second coil conductor portion from a distal end part in a portion of the first coil conductor portion, which is opposite to the first outer-side end part with a gap clamped in between, to a portion overlapping a distal end part in a portion of the second coil conductor portion, which is opposite to the second outer-side end part with a gap clamped in between.

In the coil component, a main body portion is included, and the main body portion may include a magnetic powder and contains the first spiral portion and the second spiral portion.

In the coil component, when viewed in the first direction, a ratio of a length of a first line segment, which connects a midpoint of the first low winding portion on a diagonal line of an approximate rectangle of the main body portion to a midpoint of the diagonal line, to a length of the diagonal line may be greater than 0.250.

In the coil component, when viewed in the first direction, a ratio of an average length of second line segments, each of which connects a midpoint of the first high winding portion on the diagonal line to a midpoint of the diagonal line, to the length of the first line segment may be greater than 0.9 and less than 1.1.

A further or another aspect of the present invention is directed to an electronic/electric device. In the electronic/electric device, the coil component is installed, and the coil component is connected to a board via the terminal members. Examples of the electronic/electric device include a power supply equipped with a power switching circuit, a voltage step-up circuit, a smoothing circuit, etc., and a small portable communication device. The electronic/electric device according to the present invention has an excellent overall characteristic when used as an inductance element as a result of including the above-mentioned coil component.

### Effect of the Invention

According to the present invention, a coil component having an excellent overall characteristic as an inductance element is provided. Furthermore, an electronic/electric device, in which the coil component is installed, is also provided.

### BRIEF DESCRIPTION OF THE DRAWINGS

FIG. 1 is a perspective view schematically illustrating a concept of a shape of a coil component according to an embodiment of the present invention.

FIG. 2 is a schematic diagram illustrating a structure of two spiral portions included in a coil component according to an embodiment of the present invention.

FIG. 3 is an XY plan view illustrating a structure of a first coil conductor portion included in a coil component according to an embodiment of the present invention.

FIG. 4 is an XY plan view illustrating a structure of a second coil conductor portion included in a coil component according to an embodiment of the present invention.

FIG. 5A is an XY plan view illustrating the coil component in this embodiment, showing the relationship between the inner side and the outer side of the first coil conductor portion and the inner side and the outer side of the second coil conductor portion.

FIG. 5B is an XY plan view illustrating the coil component in this embodiment, showing the relationship between an approximate rectangle of the main body portion and the first coil conductor portion.

FIG. 6 is an XY plan view illustrating a structure of a first coil conductor portion and a second conductor portion of a coil component in an embodiment of the present invention.

FIG. 7 is an XY plan view illustrating a structure of a first coil conductor portion and a second conductor portion of a coil component in a comparative example.

### DETAILED DESCRIPTION OF BEST MODE EMBODIMENTS FOR IMPLEMENTING THE INVENTION

Below, embodiments according to the present invention will be described in detail with reference to the drawings.

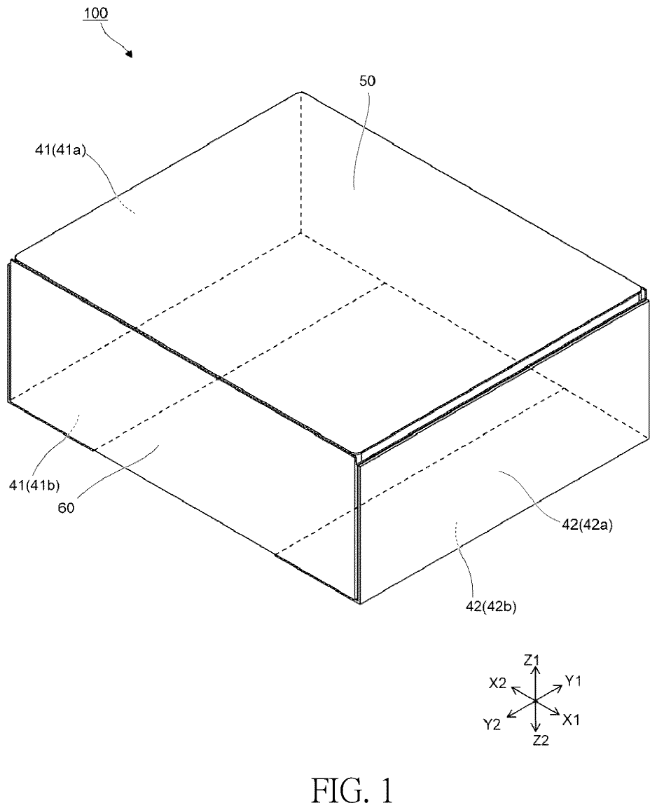

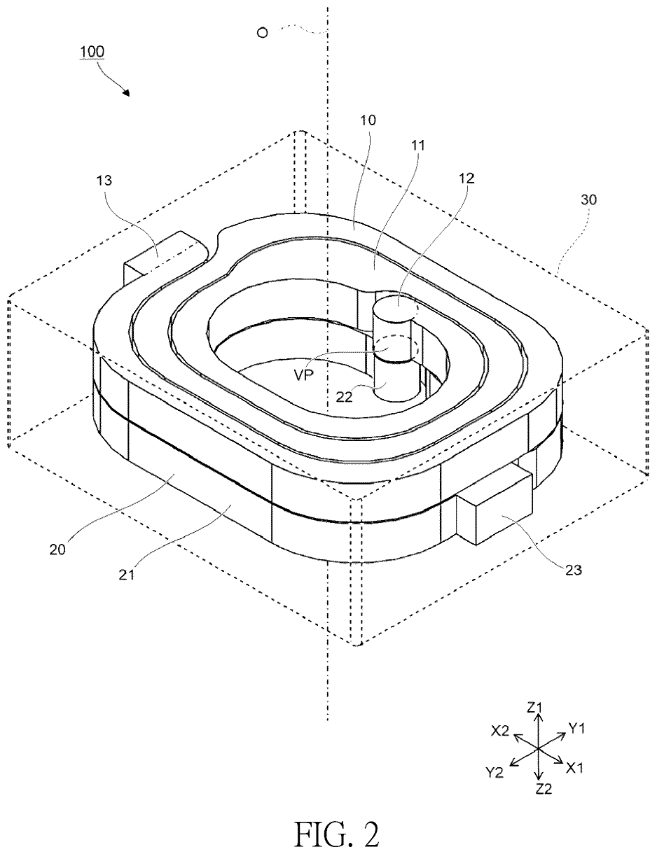

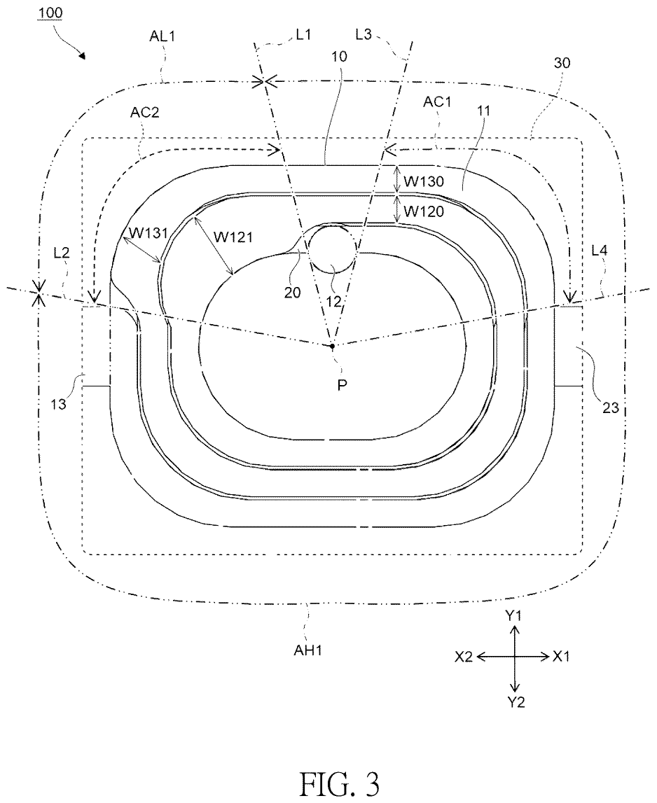

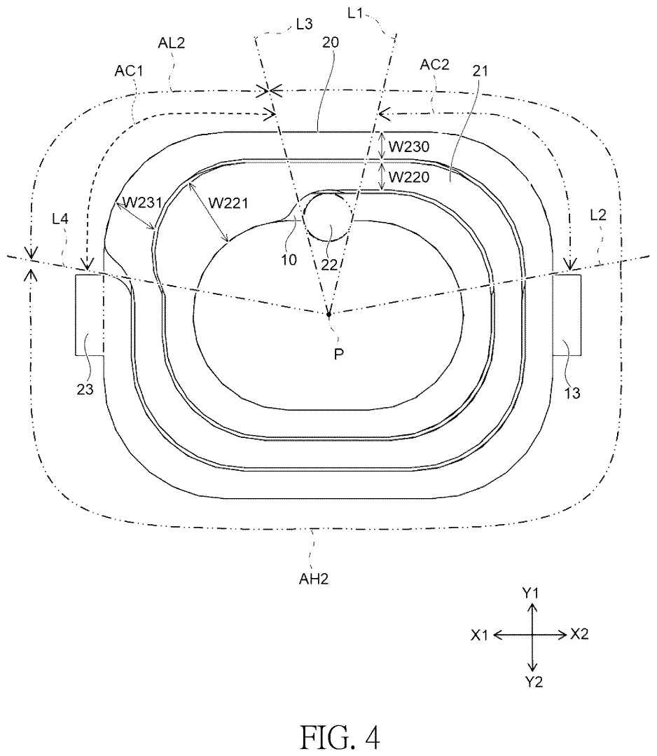

FIG. 1 is a perspective view schematically illustrating a concept of a shape of a coil component according to an embodiment of the present invention. FIG. 2 is a schematic diagram illustrating a structure of two spiral portions included in a coil component according to an embodiment of the present invention. In FIG. 2, for readily understanding, the coil conductor portion is drawn with a solid line while the main body portion (core portion) is drawn with a dashed line, and the other components are omitted from the drawing. FIG. 3 is an XY plan view illustrating a structure of a first coil conductor portion included in a coil component according to an embodiment of the present invention. Likewise, in FIG. 3, for readily understanding, the coil conductor portion is drawn with a solid line while the main body portion is drawn with a dashed line, and the other components are omitted from the drawing. FIG. 4 is an XY plan view illustrating a structure of a second coil conductor portion included in a coil component according to an embodiment of the present invention. It is to be noted that FIG. 3 is a view seen from the Z1 side in the Z1-Z2 direction, and FIG. 4 only shows the coil conductor portion seen from the Z2 side in the Z1-Z2 direction.

### (Overall Structure)

A coil component 100 according to one embodiment of the present invention includes a first coil conductor portion 10, a second coil conductor portion 20, a main body portion 30, a first terminal member 41, a second terminal member 42, and outer covers 50 and 60.

### (Coil)

As shown in FIG. 2 and FIG. 3, the first coil conductor portion 10 includes a first spiral portion 11. The first spiral portion 11 is shaped as a spiral extending from an inner-side end part 12 toward an outer-side end part 13 around an axis O in a first direction (Z1-Z2 direction), and moves away from the axis O. In FIG. 2, viewed from the Z1 side in the Z1-Z2 direction, the first spiral portion 11 is configured as a spiral shape, which extends clockwise from the inner-side end part 12 toward the outer-side end part 13 and move away from the axis O. The first inner-side end part 12 is an inner-side end part of the spiral-shaped first spiral portion 11, and the first outer-side end part 13 is an outer-side end part of the spiral-shaped first spiral portion 11.

The material used for forming the first spiral portion 11 is not limited as long as it has appropriate conductivity. Specific examples of the material used for forming the first spiral portion 11 include copper, copper alloys, aluminum, and aluminum alloys. The first spiral portion 11 can be manufactured by any suitable film forming technique, for example, plating. A coil insulator portion (not shown) is located on a surface of the first coil conductor portion 10. With the coil insulator portion, insulation between adjacent first spiral portions 11 (surfaces respective surfaces of the first spiral portions 11 facing each other) can be ensured. The coil insulator portion may be made of, for example, a resin material. The coil insulator portion is not provided in a portion of the first inner-side end part 12 and a portion of the first outer-side end part 13. Therefore, the first coil conductor portion 10 can be electrically connected to other members at these portions.

As shown in FIGS. 2 and 4, the second coil conductor portion 20 is allocated in alignment with the first coil conductor portion 10 in the first direction. The second coil conductor portion 20 has a second spiral portion 21, which is shaped as a spiral extending from the second inner-side end part 22 toward the second outer-side end part 23 around an axis O in parallel to the first direction (Z1-Z2 direction), and moves away from the axis O. The second spiral portion 21, viewed from the Z1 side in the Z1-Z2 direction, is configured as a spiral, which extends in a direction opposite to the first spiral portion (in FIG. 2, counterclockwise) and move away from the axis O. The second spiral portion 21 and the first spiral portion 11 are formed of the same conductive material. Like the first coil conductor portion 10, a coil insulator portion (not shown) is also disposed on the surface of the second coil conductor portion 20. The coil insulator portion (not shown) is also disposed between the first spiral portion 11 and the second spiral portion 21.

The first inner-side end part 12 of the first coil conductor portion 10 and a second inner-side end part 22 of the second coil conductor portion 20 are electrically connected by a via member VP. The via member VP may be made of the same conductor as the first spiral portion 11 and the second spiral portion 21, and simultaneously formed with the first spiral portion 11 and the second spiral portion 21. In this case, the via member VP is integrated with the first inner-side end part 12 of the first coil conductor portion 10 and the end part 22 of the second coil conductor portion 20. In this embodiment, in each of the first spiral portion 11 and the second spiral portion 21, the spiral direction is included in in-plane directions of planes, which have the first direction (Z1-Z2 direction), along which the axis O extends, serving as a normal line thereof. Among the in-plane directions perpendicular to the first direction, the direction (X1-X2 direction), in which the first outer-side end part 13 and a second outer-side end part 23 are aligned, is defined as a second direction, and the direction (Y1-Y2 direction) perpendicular to the first direction and the second direction is defined as a third direction.

The first spiral portion 11 of the first coil conductor portion 10 has a first high winding portion AH1 and a first low winding portion AL1 with fewer turns than the first high winding portion AH1. As shown in FIG. 3, a number of turns (turn number) of the first spiral portion 11 in the first high winding portion AH1 is 3, and a number of turns (turn number) of the first spiral portion 11 in the first low winding portion AL1 is 2. In FIG. 3, a virtual line L1 extending from the point P, which is the position of the axis O of the first coil conductor portion 10 in the XY plane, to the first inner-side end part 12, and a virtual line L2 extending from the point P to the end part 13 are shown as the boundary between the first high winding portion AH1 and the first low winding portion AL1. Herein, when viewed from the point P, in the conferential direction, the virtual line L1 is in contact with a surface of the first inner-side end part 12, which is located at a side opposite to a portion of the first spiral portion 11 extending from the first inner-side end part 12. Likewise, when viewed from the point P, in the conferential direction, the virtual line L2 is in contact with a surface of the first outer-side end part 13, which is located at a side opposite to a portion of the first spiral portion 11 extending from the first outer-side end part 13.

The turns located in the first low winding portion AL1 include a portion having a turn width, when viewed in the first direction, greater than that of the turns located in the first high winding portion AH1. In this disclosure, the expression “turn width” is defined as the distance between any specified point on the inner circumference of a turn of the first spiral portion 11 or the second spiral portion 21 and a point on the outer circumference of the same turn, which is closest to the specified point, when viewed in the first direction. The expression “width of first coil conductor portion 10” is defined as the distance between any point on the inner circumference of the innermost turn of the first spiral portion 11 and a point on the outer surface of the outermost turn of the first spiral portion 11, which is closest to that point, when viewed in the first direction. Therefore, the width of the first coil conductor portion 10 includes each gap between radially adjacent turns along the spiral direction. The width of the second coil conductor portion 20 is defined in a similar manner.

As shown in FIG. 3, in the turn width W121 of the first spiral portion 11 in the first turn of the first low winding portion AL1, there is a portion having a larger turn width than the turn width W120 of the first spiral portion 11 in the second turn of the first high winding portion AH1, which is next to the first turn of the first low winding portion AL1. Likewise, in the turn width W131 of the first spiral portion 11 in the second turn of the first low winding portion AL1, there is a portion having a larger turn width than the turn width W130 of the first spiral portion 11 in the third turn of the first high winding portion AH1, which is next to the second turn of the first low winding portion AL1.

As shown in this embodiment, the first coil conductor portion 10 having the first spiral portion 11 wound in a spiral shape is arranged such that the first inner-side end part 12 and the first outer-side end part 13 are disposed offset in the circumferential direction when viewed from the point P. For this reason, when viewed from the point P, in the circumferential direction, the first low winding portion AL1, which is an area with fewer turns, is formed between a side (X2 side in X1-X2 direction) opposite to the side, where the first spiral portion 11 extends from the first inner-side end part 12, and a side (Y1 side in Y1-Y2 direction) opposite to the side, where the first spiral portion 11 extends from the first outer-side end part 13. In the case that the cross-sectional shapes of the first spiral portion 11 are the same, the width of the first coil conductor portion 10 viewed in the first direction becomes narrower in the first low winding portion AL1 (see the comparative example described below). Therefore, by relatively increasing the turn width of the first spiral portion 11 located in the first low winding portion AL1, the cross-sectional area of the turn can be increased without changing the height of the turn (length in first direction), thereby reducing the resistance of the first coil conductor portion 10. As a result, the overall characteristic (L×Isat/DCR) of the coil component 100 can be improved when used as an inductance element.

The second coil conductor portion 21 of the second coil conductor portion 20 includes a second high winding portion AH2 and a second low winding portion AL2. As shown in FIG. 4, a number of turns (turn number) of the first spiral portion 11 in second high winding portion AH2 is 3, and a number of turns (turn number) of the first spiral portion 11 in second low winding portion AL2 is 2. In FIG. 4, a virtual line L3 extending from the point P, which is the position of the axis O of the second coil conductor portion 20 in the XY plane, to the second inner-side end part 22, and a virtual line L4 extending from the point P to the second outer-side end part 23 are shown as the boundary between the second high winding portion AH2 and the second low winding portion AL2. Herein, when viewed from the point P, in the conferential direction, the virtual line L3 is in contact with a surface of the second inner-side end part 22, which is located at a side opposite to a portion of the second spiral portion 21 extending from the second inner-side end part 22. Likewise, when viewed from the point P, in the conferential direction, the virtual line L4 is in contact with a surface of the second outer-side end part 23, which is located at a side opposite to a portion of the second spiral portion 21 extending from the second outer-side end part 23.

The turns located in the second low winding portion AL2 include a portion having a turn width, when viewed in the first direction, larger than that of the turns located in the second high winding portion AH2. Specifically, as shown in FIG. 4, in the turn width W221 of the second spiral portion 21 in the first turn of the second low winding portion AL2, there is a portion having a larger turn width than the turn width W220 of the second spiral portion 21 in the second turn of the second high winding portion AH2, which is next to the first turn of the second low winding portion AL1. Likewise, in the turn width W231 of the second spiral portion 21 in the second turn of the second low winding portion AL2, there is a portion having a turn width larger than the turn width W230 of the second spiral portion 21 in the third turn of the second high winding portion AH2, which is next to the second turn of the second low winding portion AL2.

Also in the second coil conductor portion 20, similar to the first coil conductor portion 10, the second inner-side end part 22 and the second outer-side end part 23 are disposed offset in the circumferential direction, the second low winding portion AL2 is formed. Therefore, by relatively increasing the turn width of the second spiral portion 21 located in the second low winding portion AL2, the resistance of the second coil conductor portion 20 can be reduced. As a result, the overall characteristic (L×Isat/DCR) of the coil component 100 can be improved when used as an inductance element.

As shown in FIG. 4, the second coil conductor portion 20 has a second opposing portion AC2, which is disposed opposite to the first low winding portion AL1 in the first direction. The second opposing portion AC2 is defined as a region of the second coil conductor portion 20, which is sandwiched between the virtual line L1 and the virtual line L2 when viewed from the Z2 side in the Z1-Z2 direction. Since the coil insulator portion (not shown) is disposed between the first coil conductor portion 10 and the second coil conductor portion 20, insulation is shown between the first low winding portion AL1 and the second opposing portion AC2, which are disposed opposite to each other.

At least one of respective inner circumferences and respective outer circumferences of the first low winding portion AL1 and the second opposing portion AC2 has an overlapping portion in the first direction. In this embodiment, as shown in FIG. 3, almost the entire inner circumference of the first low winding portion AL1 (specifically, except for the vicinity of the first inner-side end part 12) overlaps with the inner circumference of the second opposing portion AC2 in the first direction. In addition, almost the entire outer circumference of the first low winding portion AL1 (specifically, except for the vicinity of the first outer-side end part 13) overlaps with the outer circumference of the second opposing portion AC2 in the first direction. Therefore, the first low winding portion AL1 and the second opposing portion AC2 have portions with the same width as viewed in the first direction. Specifically, in the portion of the first low winding portion AL1 except for the vicinity of the first inner-side end part 12 and the vicinity of the first outer-side end part 13, the width is equal to the width of the second opposing portion AC2.

As shown in FIG. 3, the first coil conductor portion 10 has a first opposing portion AC1 disposed opposite to the second low winding portion AL2 in the first direction. When viewed from the Z1 side in the Z1-Z2 direction, the first opposing portion AC1 is defined as a region of the first coil conductor portion 10, which is sandwiched between the virtual line L3 and the virtual line L4. Since the coil insulator portion (not shown) is provided between the second coil conductor portion 20 and the first coil conductor portion 10, the second low winding portion AL2 and the first opposing portion AC1, which are disposed opposite to each other, are insulated from each other.

At least one of respective inner circumferences and respective outer circumferences of the second low winding portion AL2 and the second opposing portion AC1 has an overlapping portion in the first direction. In this embodiment, as shown in FIG. 4, almost the entire inner circumference of the second low winding portion AL2 (specifically, except for the vicinity of the second inner-side end part 22) overlaps with the inner circumference of the first opposing portion AC1 in the first direction. In addition, almost the entire outer circumference of the second low winding portion AL2 (specifically, except for the vicinity of the second outer-side end part 23) overlaps with the outer circumference of the first opposing portion AC1 in the first direction. Therefore, the second low winding portion AL2 and the first opposing portion AC1 have portions with the same width as viewed in the first direction. Specifically, in the portion of the second low winding portion AL2 except for the vicinity of the second inner-side end part 22 and the vicinity of the second outer-side end part 13, the width is equal to the width of the first opposing portion AC1.

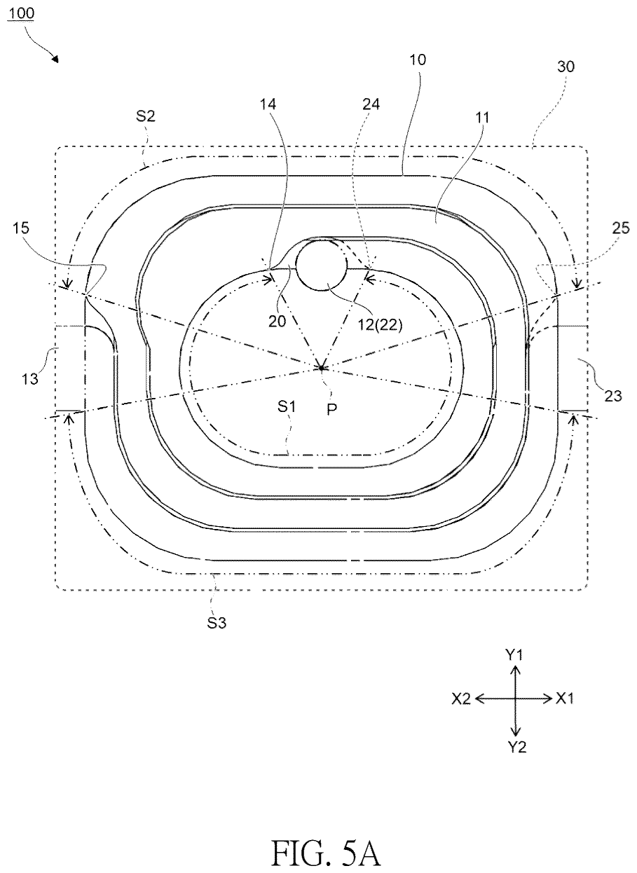

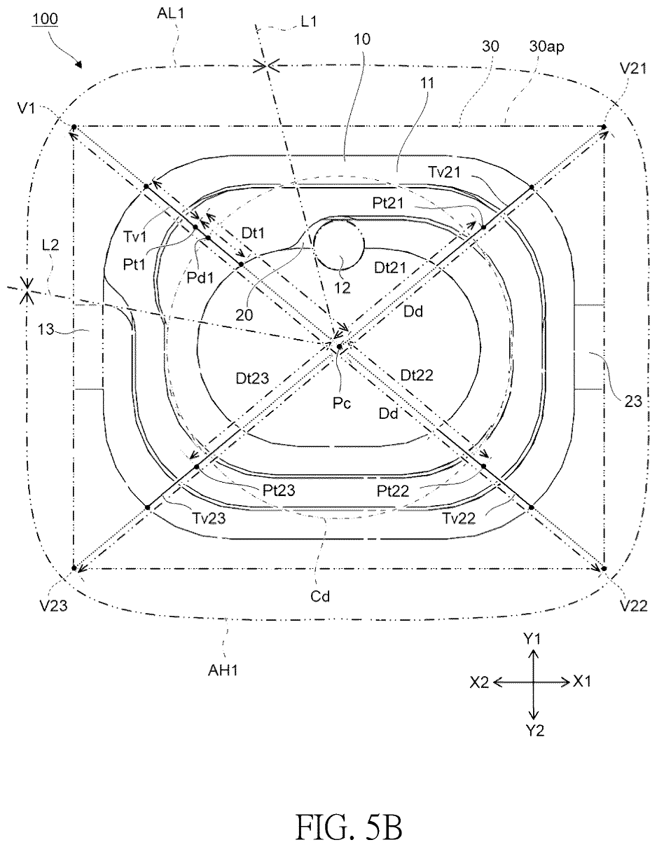

FIG. 5A is an XY plan view illustrating the relationship between the inner circumference and the outer circumference of the first coil conductor portion and the inner circumference and the outer circumference the second coil conductor portion of the coil component according to an embodiment. In the coil component 100 in this embodiment, as a specific example, the inner circumference and the outer circumference of the first coil conductor portion 10 and the inner circumference and the outer circumference of the second coil conductor portion 20 have the relationship as described below.

When viewed in the first direction, the inner circumference of the first coil conductor portion 10 coincides with the inner circumference of the second coil conductor portion 20 from a distal end part 14 in a portion of the first coil conductor portion 10, which is opposite to the first inner-side end part 12 with a gap clamped in between, to a portion overlapping a distal end part 24 in a portion of the second coil conductor portion 20, which is opposite to the second inner-side end part 22 with a gap clamped in between. This portion, where the inner circumferences coincide, is the range indicated by S1 in FIG. 5A.

In addition, when viewed in the first direction, the outer circumference of the first coil conductor portion 10 coincides with the outer circumference of the second coil conductor portion 20 from a distal end part 15 in a portion of the first coil conductor portion 10, which is opposite to the first outer-side end part 13 with a gap clamped in between, to a portion overlapping a distal end part 25 in a portion of the second coil conductor portion 20, which is opposite to the second outer-side end part 23 with a gap clamped in between. This portion, where the outer circumferences coincide, is the range indicated by S2 in FIG. 5A.

Furthermore, when viewed in the first direction, the outer circumference of the first coil conductor portion 10 coincides with the outer circumference of the second coil conductor portion 20 from a portion overlapping a portion in connection with the second outer-side end part 23 in the second coil conductor portion 20 to a portion in connection with the first outer-side end part 13 in the first coil conductor portion 10. This portion, where the outer circumferences coincide, is the range indicated by S3 in FIG. 5A.

In this way, with a portion where the inner circumference of the first coil conductor portion 10 and the inner circumference of the second coil conductor portion 20 overlap with each other, when viewed in the first direction, and with a portion where the outer circumference of the first coil conductor portion 10 and the outer circumference of the second coil conductor portion 20 overlap with each other, when viewed in the first direction, the DCR of the coil component 100 can be appropriately reduced. Furthermore, in a case that the coil component 100 is molded (to be described later in detail), stress can be applied uniformly to the first coil conductor portion 10 and the second coil conductor portion 20.

FIG. 5B is a scheme illustrating the coil component in this embodiment, showing the relationship between an approximate rectangle of the main body portion and the first coil conductor portion. The coil component 100 in this embodiment preferably has the following feature 1, and more preferably further has feature 2.

### (Feature 1)

As the feature 1, the coil component 100 according to this embodiment preferably satisfies a condition that, when viewed in the first direction, a ratio (first ratio R1) of the length of a first line segment, which connects a midpoint of the first low winding portion AL1 on a diagonal line of the approximate rectangle of the main body portion 30 to a midpoint of this diagonal line, to the length of the diagonal line is greater than 0.250.

As shown in FIG. 5B, the main body portion 30, when viewed from the first direction, is shaped approximately as a rectangle, which is referred to as an approximate rectangle 30ap. The approximate rectangle 30ap has four vertices V1, V21~V23, and two diagonal lines (diagonal line V1V22 and diagonal line V21V23). The vertex V1 is a vertex proximal to the first low winding portion AL1, and the vertices V21-V23 are vertices proximal to the first high winding portion AH1.

When viewed in the first direction, the only diagonal line that overlaps with the first low winding portion AL1 is the diagonal line V1V22. The portion of the diagonal line V1V22 on the first low winding portion AL1 is the line segment Tv1, and the length of the first line segment Pt1Pc connecting a point Pt1, which is a midpoint of the line segment Tv1, and a midpoint Pc of the diagonal line V1V22 is Dt1. On the other hand, with the midpoint Pc of the diagonal line V1V22 serving as a center point, among the intersection points of a virtual circle Cd, whose radius is equal to a quarter of the length Dd of the diagonal line V1V22, and the diagonal line V1V22, the intersection point on the first low winding portion AL1 is the point Pd1. In this case, the length of the line segment Pd1Pc is 0.250 times the length Dd of the diagonal line V1V22.

As shown in FIG. 5B, when viewed from the midpoint Pc, the point Pt1 is more distal than the point Pd1. In other words, the point Pt1 is closer to the vertex V1 than the point Pd1. Therefore, the ratio (first ratio R1) of the length Dt1 of first line segment Pt1Pc to the length Dd of the diagonal line V1V22 is greater than 0.250. Since the first ratio R1 is greater than 0.250, the first low winding portion AL1 is located relatively close to the vertex V1. Thus the induced magnetic field of the coil can easily reach the area of the main body portion 30 near the vertex V1, i.e., a corner of the main body portion 30, and the overall characteristic (L×Isat/DCR) of the coil component 100 can be easily enhanced. Preferably, the second low winding portion AL2 has the same feature.

### (Feature 2)

As the feature 2, the coil component 100 according to this embodiment preferably satisfies a condition that, when viewed in the first direction, a ratio of the average length of second line segments, each of which connects a midpoint of the first high winding portion AH1 on the diagonal line of the approximate rectangle of the main body portion 30 to a midpoint of the diagonal line, to the length of the first line segment is from 0.9 to 1.1.

When viewed in the first direction, the first high winding portion AH1 has one overlapping portion on the diagonal line V1V22 and two overlapping portions on the diagonal line V21V23. The portion where the first high winding portion AH1 overlaps with the diagonal line V1V22 is the line segment Tv22, and the portions where the first high winding portion AH1 overlaps with the diagonal line V21V23 are the line segment Tv21 and the line segment Tv23.

The length of a second line segment Pt21Pc connecting a point Pt21, which is a midpoint of the line segment Tv21, to the midpoint Pc is referred to as Dt21, the length of a second line segment Pt22Pc connecting a point Pt22, which is a midpoint of the line segment Tv22, to the midpoint Pc is referred to as Dt22, and the length of a second line segment Pt23Pc connecting a point Pt23, which is a midpoint of the line segment Tv22, to the midpoint Pc is referred to as Dt23. A ratio (second ratio R2) of the average value D of the lengths Dt21, Dt22, and Dt23 of these second line segments Pt21Pc, Pt22Pc, and Pt23Pc to the length Dt1 of the first line segment Pt1Pc is preferably in the range of 0.9 to 1.1. By having the average value D of the length of the second line segment and the length Dt1 of the first line segment satisfy the above relationship, the outer shape of a portion of the first high winding portion AH1, which is curved in a manner similar to the first low winding portion AL1, becomes closer to the first low winding portion AL1, making it easier to appropriately reflect the influence based on the feature of the outer shape of the first low winding portion AL1 in the coil component 100. It is preferable that the second low winding portion AL2 and the second high winding portion AH2 also have the same features.

The dimensions of the turns of the first spiral portion 11 and the second spiral portion 21 are not limited. For example, the height (turn thickness) in the first direction of turns of the first spiral portion 11 and the second spiral portion 21 may be 30 to 400 μm. Also, for example, the turn width of the first spiral portion 11 and the second spiral portion 21 may be 10 to 100 μm. The gap between adjacent turns of the first spiral portion 11 and the second spiral portion 21 in the width direction may be 3 to 30 μm.

### (Main Body Portion)

The main body portion 30 contains magnetic powder and contains the first spiral portion 11 of the first coil conductor portion 10 and the second spiral portion 21 of the second coil conductor portion 20. In this embodiment, the main body portion 30 has a substantially rectangular parallelepiped shape and is located on the inner side and the outer side of the first coil conductor portion 10 and the second coil conductor portion 20, covering all but the end of the first outer-side end part 13 of the first spiral portion 11 of the first coil conductor portion 10 and the end of the second outer-side end part 23 of the second spiral portion 21 of the second coil conductor portion 20.

The structure of the magnetic powder is not limited. This structure may include a crystalline phase or an amorphous phase. Herein, a crystalline material is defined as a material formed of a crystalline phase, an amorphous material is defined as a material formed of an amorphous phase, and a composite material is defined as a material including a crystalline material and an amorphous material. In a situation that the diffraction spectrum obtained by a general X-ray diffraction method includes a sharp diffraction peak that can identify the type of crystalline phase, the material includes a crystalline phase. On the other hand, in the situation that the diffraction spectrum obtained by a general X-ray diffraction method includes a broad peak indicating an amorphous phase, the material includes an amorphous phase. If the DSC curve obtained by differential thermal analysis includes a peak indicating crystallization, i.e., heat generation associated with a phase change from an amorphous phase to a crystalline phase, the material includes an amorphous phase.

The material system of the magnetic powder is not limited. Specific examples of the crystalline material include Fe—Si—Cr based alloys, Fe—Ni based alloys, Fe—Co based alloys, Fe—V based alloys, Fe—Al based alloys, Fe—Si based alloys, Fe—Si—Al based alloys, iron only, and ferrite. It is preferable to use carbonyl iron powder as iron-only powder. Specific examples of the amorphous material include Fe—Si—B based alloys, Fe—P—C based alloys, and Co—Fe—Si—B based alloys. Specific examples of composite materials include Fe—Zr based alloys, Fe—Zr—B based alloys, Fe—Si—B—Nb—Cu based alloys, and Fe—Si—B—P—Cu based alloys. If the magnetic powder is metal powder containing Fe, the synergistic effect on improvement of magnetic properties is particularly significant.

The chemical composition of the magnetic powder is not limited. For example, the Fe—Si—Cr based alloy may be composed of 1.0-10.0 mass % Si, 1.0-10.0 mass % Cr, and the remainder composed of Fe and impurities. Also, for example, the Fe—Ni based alloy may be composed of 1.0-99.0 mass % Ni, and the remainder composed of Fe and impurities. Furthermore, for example, the Fe—P—C based alloy may be composed of 1.0-13.0 atom % P, 1.0-13.0 atom % C, Fe, and impurities. The Fe—P—C based alloy may contain one or more optional elements selected from the group consisting of Ni, Sn, Cr, B, and Si. In this case, for example, the amount of Ni may be 0 to 10.0 atomic %, the amount of Sn may be 0 to 3.0 atom %, the amount of Cr may be 0 to 6.0 atom %, the amount of B may be 0 to 9.0 atom %, and the amount of Si may be 0 to 7.0 atom %. The amount of Fe is preferably 65 atom % or more. Also, for example, the Fe—Si—B—Nb—Cu based alloy may be composed of 1.0 to 16.0 atom % Si, 1.0 to 15.0 atom % B, 0.50 to 5.0 atom % Nb, 0.50 to 5.0 atom % Cu, and the balance consisting of Fe and impurities. In this case, the amount of Fe is preferably 65 atom % or more.

The shape of the magnetic powder contained in the main body portion 30 is not limited. The magnetic powder may be spherical, elliptical, scaly, or of an irregular shape. The manufacturing method for rendering these shapes is also not limited.

The particle size distribution of the magnetic powder is not limited. The particle size distribution of the magnetic powder can be obtained, for example, by analyzing an image (secondary electron image), which is an image of a cut surface of the main body portion 30 obtained with a scanning electron microscope. For example, the average equivalent circular diameter of the magnetic powder may be 0.50 to 50.0 μm. The distribution of the equivalent circular diameter may include multiple peaks.

The magnetic powder may be subjected to a surface insulating treatment. Provided that the magnetic powder is subjected to a surface insulating treatment, the insulation resistance of the main body portion 30 is improved. There is no limitation on the type of surface insulating treatment applied to the magnetic powder. Examples include phosphoric acid treatment, phosphate treatment, and oxidation treatment. The magnetic powder may have an insulating coating on the surface of the magnetic particles. This insulating coating may contain at least one selected from a group consisting of Si, P, and B, and O (oxygen).

The magnetic powder may be a mixed material in which multiple powder materials are mixed. This magnetic powder is preferably a ferromagnetic material, and more preferably a soft magnetic material.

The main body portion 30 may further include an optional auxiliary material. The optional auxiliary material is, for example, a binder material or a modifier. The binder material bonds particles such as magnetic powder contained in the main body portion 30 together. This binder material is preferably an insulating material to impart insulation resistance to the main body portion 30.

The binding component may be an organic material or an inorganic material. The organic material may be a resin material. Examples of the resin material include acrylic resin, silicone resin, epoxy resin, phenol resin, urea resin, melamine resin, and polyester resin. The inorganic material may be a glass-based material such as water glass. The binding material may be a product of a reaction such as thermal decomposition, or may be a mixture of multiple materials.

The modifier, for example, improves the mobility of the powder or adjusts the curing speed of the binder material. The modifier may be a glass-based material.

The dimension of the main body portion 30 is not limited. For example, the maximum dimension of the main body portion 30 may be 3.2 mm or less.

### (External Terminal)

As shown in FIG. 2, an end of the first outer-side end part 13 of the first coil conductor portion 10 and an end of the second outer-side end part 23 of the second coil conductor portion 20 are exposed from side surfaces aligned in the X1-X2 direction in the main body portion 30. A first terminal member 41 is provided to be in electric contact with the exposed end of the first outer-side end part 13, and a second terminal member 42 is disposed to be in electric contact with the exposed end of the second outer-side end part 23.

The first terminal member 41 has a side portion 41a of the first terminal member, which covers the side surface of the main body portion 30 on the X2 side in the X1-X2 direction, and a bottom portion 41b of the first terminal member, which is provided to cover partially the bottom surface (surface on Z2 side in Z1-Z2 direction) of the main body portion 30. The bottom portion 41b of the first terminal member is a part facing the board when in use. The second terminal 42 has a side portion 42a of the second terminal member, which covers the side surface of the main body portion 30 on the X1 side in the X1-X2 direction, and a bottom portion 42b of the second terminal member, which is provided on the bottom surface of the main body portion 30 to cover partially the bottom surface while being spaced apart from the bottom portion 41b. The bottom portion 42b of the second terminal member also faces the board when in use.

The positions of the first terminal member 41 and the second terminal member 42 are not limited to the positions described above. The first terminal member 41 and the second terminal member 42 may also be formed to cover partially the upper surface of the main body portion 30. The first terminal member 41 and the second terminal member 42 may also be disposed on only a part of the bottom surface of the main body portion 30. In this case, the first coil conductor portion 10 and the second coil conductor portion 20 may respectively include a connecting conductor (not shown), which connects the end of the first outer-side end part 13 of the first coil conductor portion 10 and the end of the second outer-side end part 23 of the second coil conductor portion 20 to the bottom surface of the main body portion 30 through the inside of the main body portion 30. Furthermore, the end of the first outer-side end part 13 of the first coil conductor portion 10 and the end of the second outer-side end part 23 may not be exposed from the side surface of the main body portion 30, while the connecting conductor may be exposed from the bottom surface of the main body portion 30.

The material and configuration of the first terminal member 41 and the second terminal member 42 are not limited as long as they have appropriate conductivity. One non-limiting example of the first terminal member 41 and the second terminal member 42 is a layer having a structure of Cu plating/Ni plating/Sn plating from the side proximal to the surface of the main body portion 30. The first terminal member 41 and the second terminal member 42 may be composed of a coated electrode, in which a conductive material such as silver is dispersed in a resin or the like. The first terminal member 41 and the second terminal member 42 may also be a combination of plated layer and coated electrode.

### (Outer Cover)

The upper surface of the main body portion 30 (surface on Z1 side in Z1-Z2 direction) and the side surfaces in the Y1-Y2 direction are each provided with an insulating outer cover 50, 60. An insulating outer cover may also be provided on a portion of the bottom surface of the main body portion 30, where the bottom surface portion 41b of the first terminal member and the bottom surface portion 42b of the second terminal member are not provided. Furthermore, the coil component 100 may not be provided with the outer covers 50 and 60. The outer covers 50 and 60 can be formed at any position on the surface of the main body portion 30 depending on purposes.

### (Manufacturing Method)

The manufacturing method of the coil component according to this embodiment is not particularly limited. One non-limiting example of the manufacturing method is as follows.

First, an insulating negative pattern corresponding to the first coil conductor portion 10 is formed on one side of an insulating substrate such as glass epoxy or polyimide, and an insulating negative pattern corresponding to the second coil conductor portion 20 is formed on the other side of the substrate. The base material has a through hole in a portion corresponding to the via member VP.

By copper plating both sides of the negative patterned substrate thus obtained and then removing the negative pattern, a structure having the first coil conductor portion 10 made of copper plating on one side, having the second coil conductor portion 20 made of copper plating on the other side, and having the two col conductors electrically connected by the via member VP, which is formed by filling the copper plating into the through hole of the substrate, is obtained.

This structure is disposed in a mold cavity that has a cavity corresponding to the main body portion 30. The magnetic powder prepared as described above is filled into the mold cavity, and a molding process including pressurization, heating, etc., is performed to obtain the main body portion 30 including the first coil conductor portion 10 and the second coil conductor portion 20.

The first terminal member 41 is provided to be electrically connected to the end of the first outer-side end part 13 exposed from the side surface of the main body portion 30, and the second terminal member 42 is provided to be electrically connected to the end of the second outer-side end part 23 that is also exposed. Finally, the outer covers 50 and 60 are provided to cover the exposed portion of the main body portion 30, thereby obtaining the coil component 100.

### (Electronic/Electric Device)

The electronic/electrical device according to one embodiment of the present invention is an electronic/electric device in which the coil component 100 according to one embodiment of the present invention is installed. The coil component 100 is connected to a board with the first terminal member 41 and the second terminal member 42. The electronic/electric device according to an embodiment of the present invention can be easily miniaturized because it is mounted with the coil component 100 according to an embodiment of the present invention. Furthermore, even if a large current passes through the device or a high frequency is applied, malfunctions caused by deterioration of the function of the coil component 100 or heat generation are unlikely to occur.

### Embodiment

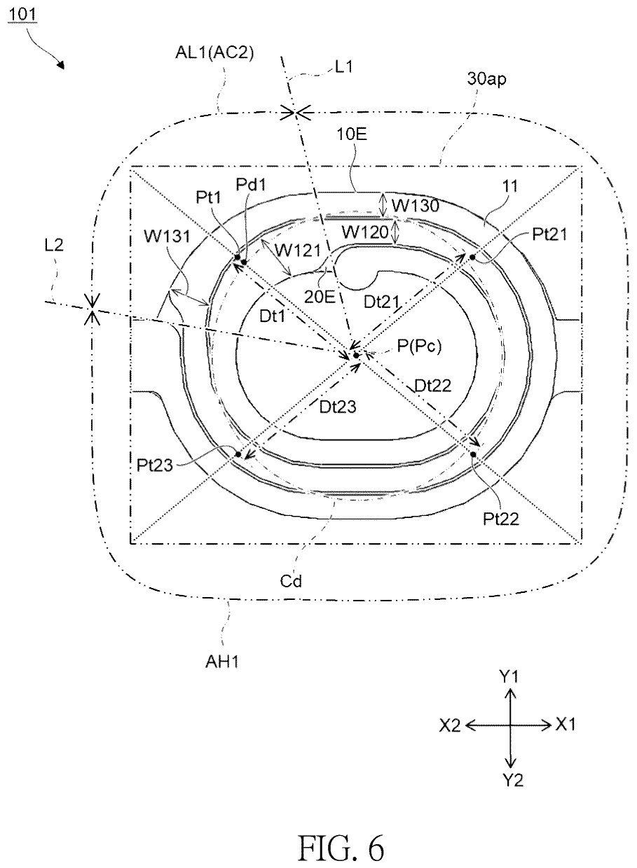

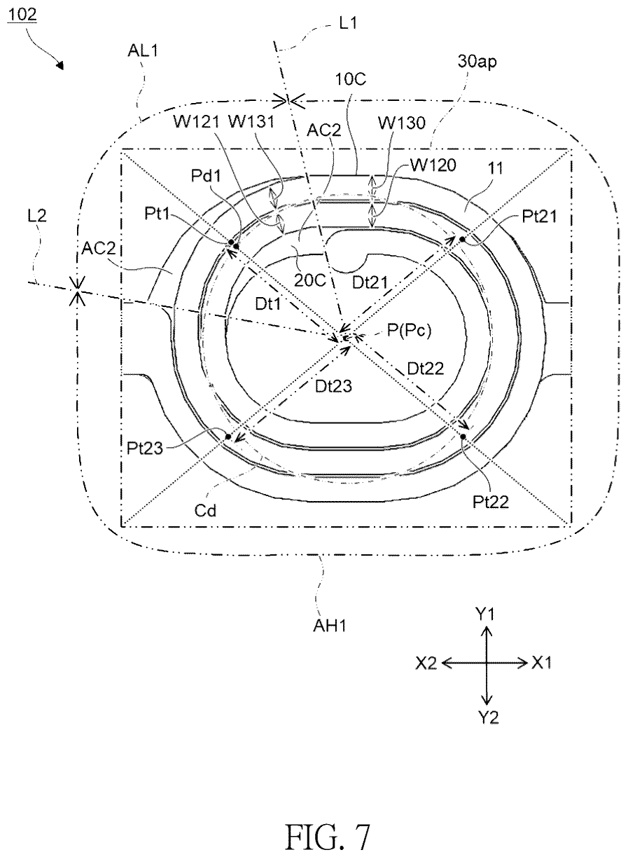

FIG. 6 is an XY plan view illustrating a structure of a first coil conductor portion and a second conductor portion of a coil component in an embodiment of the present invention. FIG. 7 is an XY plan view illustrating a structure of a first coil conductor portion and a second conductor portion of a coil component in a comparative example.

As shown in FIG. 6, the outer shapes of the first coil conductor portion 10E and the second coil conductor portion 20E, when viewed from the first direction, are different from those of the first coil conductor portion 10 and the second coil conductor portion 20 shown in FIG. 2, etc. Except for the outer shapes, their configurations are the same and both include a first low winding portion AL1. In the first low winding portion AL1, a turn width W121, W131 of the first spiral portion 11 has a portion wider than a turn width W120, W130 of another portion. Furthermore, in the second coil conductor portion 20E, a width of a second opposing portion AC2, which is disposed opposite to the first low winding portion AL1 in the first direction, has a portion equal to the width of the first low winding portion AL1.

### Comparative Example

A first coil conductor portion 10C and a second coil conductor portion 20C according to a comparative example shown in FIG. 7 are common to the first coil conductor portion 10E and the second coil conductor portion 20E, except for the shapes of the first low winding portion AL1 and the second low winding portion AL2 (not visible in FIG. 7). In the first coil conductor portion 10C, the turn widths W121 and W131 of the first spiral portion 11 in the first low winding portion AL1 are equal to the turn widths W120 and W130 of the other portions. Therefore, the width of the first low winding portion AL1 is narrower than the width of the second opposing portion AC2, which is a portion in the second coil conductor portion 20E opposite to the first low winding portion AL1. In FIG. 7, as viewed from the Z1 side in the Z1-Z2 direction, portions in the second opposing portion AC2, which do not overlap with the first low winding portion AL1, are visible on the inner side and the outer side of the first low winding portion AL1.

Simulations are performed on a coil component 101 including the first coil conductor portion 10E and the second coil conductor portion 20E shown in FIG. 6, and a coil component 102 including the first coil conductor portion 10C and the second coil conductor portion 20C shown in FIG. 7. The dimensions of the coil components 101 and 102 are as follows.

### (Common Dimensions of Coil Components 101 and 102)

Main body portion 30: 1.25 mm×1.05 mm×0.45 mm
Length of the diagonal line of the approximate rectangle 30ap of the main body portion 30: 1.63 mm
Thickness of the coil insulator portion disposed between the first coil conductor portion 10E, 10C and the second coil conductor portion 20E, 20C: 5 μm
Turn thickness: 120 μm
Turn width of the coil component 101 except for the first low winding portion AL1: 68 μm to 70 μm
Gap between adjacent turns in the spiral in the radial direction: 8 μm (excluding coil insulator portion)
Width of the first high winding portion AH1 and the second high winding portion AH2 (see FIG. 4): 220 μm to 226 μm
Radius of the approximate arc of inner circumference: 0.23 mm
Radius of the approximate arc of outer circumference: 0.45 mm

### (Detailed Dimensions of Coil Component 101)

Width of the first lower winding portion AL1 and the second lower winding portion AL2 (see FIG. 4): 226 μm
Length of the first line segment Dt1: 415 μm
Length of second line segment Dt21 to Dt23: 415 μm

### (Detailed Dimensions of Coil Component 102)

Width of the first lower winding portion AL1 and the second lower winding portion AL2: 144 μm
Length of first line segment Dt1: 417 μm
Length of the second line segment Dt21 to Dt23: 417 μm

The following features are obtained through simulation.
Self-inductance L (unit: μH)
DC resistance DCR (unit: mΩ)
DC superimposed rated current Isat (unit: A)

In this disclosure, the DC superimposed rated current Isat refers to the current value at which the self-inductance L decreases by 30% when DC is superimposed.

The results of the simulation are shown in Table 1. The improvement rate (unit: %) in Table 1 is calculated according to {(overall characteristic of the embodiment (L×Isat/DCR)−overall characteristic of the comparative example)}/overall characteristic of the comparative example×100.

TABLE 1

| | Embodiment | Comparative Example |
|---|---|---|
| L [μH] | 0.348 | 0.359 |
| DCR [mΩ] | 28.7 | 29.8 |
| Isat [A] | 3.70 | 3.65 |
| L/DCR | 0.0121 | 0.0120 |
| L × Isat | 1.29 | 1.31 |
| L × Isat/DCR | 0.0448 | 0.0439 |
| improvement rate | 2.1% | — |
| First ratio R1 | 0.255 | 0.256 |
| Second ratio R2 | 1.0 | 1.0 |

As shown in Table 1, the embodiment, in which the widths of the first low winding portion AL1 and the second low winding portion AL2 are equal to those of other portions (first high winding portion AH1, second high winding portion AH2), has a lower DC resistance DCR and a higher DC superimposed rated current Isat than the comparative example, in which the widths of the first low winding portion AL1 and the second low winding portion AL2 are narrower than those of other portions (first high winding portion AH1, second high winding portion AH2). Therefore, the coil component in this embodiment has an improvement of 2% or more compared to the coil component of the comparative example in terms of L×Isat/DCR, which is the overall characteristic of the coil component, when used as an inductance element.

Furthermore, from the detailed dimensions of the coil components 101 and 102, the ratio (first ratio R1) of the length Dt1 of the first line segment to the length of the diagonal line of the approximate rectangle 30ap and the ratio (second ratio R2) of the average value D of the lengths Dt21 to Dt23 of the second line segments to the length Dt1 of the first line segment are obtained as shown in Table 1. The first ratio R1 is 0.255 in the embodiment, which is greater than 0.250. In the comparative example, the first ratio R1 is 0.256, which is almost the same value as in the embodiment. Furthermore, the second ratio R2 is 1.0 in both the embodiment and the comparative example, and the outer shapes of the four curved parts are all similar. In this way, in the embodiment and the comparative example, since the shape features are the same except for the width of the first low winding portion AL1 and the width of the second low winding portion AL2, L×Isat are the same.

The above-described embodiments and examples are described to facilitate understanding of the present invention, and are not described to limit the present invention. Therefore, each element disclosed in the above embodiments and examples is intended to include all design modifications and equivalents that fall within the technical scope of the present invention.

### DESCRIPTIONS OF REFERENCE NUMERALS

100, 101, 102: coil component
10, 10C, 10E: first coil conductor portion
11: first spiral portion
21: second spiral portion
12: first inner-side end part
13: first outer-side end part
22: second inner-side end part
23: second outer-side end part
14, 15, 24, 25: distal end part
20, 20C, 20E: second coil conductor portion
30: main body portion
30ap: approximate rectangle
41: first terminal member
41a: side portion of first terminal member
41b: bottom portion of first terminal member
42: second terminal member
42a: side portion of second terminal member
42b: bottom portion of second terminal member
50, 60: outer cover
AC1: first opposing portion
AC2: second opposing portion
AH1: first high winding portion
AH2: second high winding portion
AL1: first low winding portion
AL2: second low winding portion
Cd: virtual circle
Dd, Dt1, Dt21-Dt23: length
L1~L4: virtual line
O: axis
P, Pd1, Pt1, Pt21~Pt23: point
Pc: midpoint
S1~S3: range
Tv1, Tv21~Tv23: line segment
V1, V21~V23: vertex
VP: via member
W120, W121, W130, W131, W220, W221, W230, W231: turn width

1. A coil component, comprising:
a first coil conductor portion comprising a first spiral portion, which is shaped as a spiral extending from a first inner-side end part toward a first outer-side end part around an axis in a first direction and moving away from the axis;
a second coil conductor portion comprising a second spiral portion, which is shaped as a spiral extending from a second inner-side end part toward a second outer-side end part around the axis and oppositely relative to the first spiral portion, and moving away from the axis, the second coil conductor portion being aligned with the first coil conductor portion in the first direction;
a via member electrically connected to the first inner-side end part and the second inner-side end part;
a first terminal member electrically connected to the first outer-side end part; and
a second terminal member electrically connected to the second outer-side end part,
wherein the first spiral portion comprises a first high winding portion and a first low winding portion with a less turn number compared with the first high winding portion, and a turn disposed in the first low winding portion comprises a portion having a turn width, when viewed in the first direction, greater than that of a turn disposed in the first high winding portion.

2. The coil component according to claim 1, wherein the second coil conductor portion comprises a second opposing portion, which is disposed opposite to the first low winding portion in the first direction, and at least one of respective inner circumferences and respective outer circumferences of the second opposing portion and the first low winding portion have overlapping portions in the first direction.

3. The coil component according to claim 2, wherein the first low winding portion and the second opposing portion have equal-width portions in the first direction.

4. The coil component according to claim 1, wherein the second spiral portion comprises a second high winding portion and a second low winding portion with a less turn number compared with the second high winding portion, and a turn disposed in the second low winding portion comprises a portion having a turn width, when viewed in the first direction, greater than that of a turn disposed in the second high winding portion.

5. The coil component according to claim 4, wherein the first coil conductor portion comprises a first opposing portion, which is disposed opposite to the second low winding portion in the first direction, and at least one of respective inner circumferences and respective outer circumferences of the first opposing portion and the second low winding portion have overlapping portions in the first direction.

6. The coil component according to claim 5, wherein the second low winding portion and the first opposing portion have equal-width portions in the first direction.

7. The coil component according to claim 1, wherein an insulating coil insulator portion is disposed between the first spiral portion and the second spiral portion.

8. The coil component according to claim 1, when viewed in the first direction, satisfying conditions of:
an inner circumference of the first coil conductor portion coincides with an inner circumference of the second coil conductor portion from a distal end part in a portion of the first coil conductor portion, which is opposite to the first inner-side end part with a gap clamped in between, to a portion overlapping a distal end part in a portion of the second coil conductor portion, which is opposite to the second inner-side end part with a gap clamped in between,
an outer circumference of the first coil conductor portion coincides with an outer circumference of the second coil conductor portion from a portion overlapping a portion in connection with the second outer-side end part to a portion in connection with the first outer-side end part, and
the outer circumference of the first coil conductor portion coincides with the outer circumference of the second coil conductor portion from a distal end part in a portion of the first coil conductor portion, which is opposite to the first outer-side end part with a gap clamped in between, to a portion overlapping a distal end part in a portion of the second coil conductor portion, which is opposite to the second outer-side end part with a gap clamped in between.

9. The coil component according to claim 1, comprising a main body portion comprising a magnetic powder and containing the first spiral portion and the second spiral portion.

10. The coil component according to claim 9, wherein when viewed in the first direction, a ratio of a length of a first line segment, which connects a midpoint of the first low winding portion on a diagonal line of an approximate rectangle of the main body portion to a midpoint of the diagonal line, to a length of the diagonal line is greater than 0.250.

11. The coil component according to claim 10, wherein when viewed in the first direction, a ratio of an average length of second line segments, each of which connects a midpoint of the first high winding portion on the diagonal line to a midpoint of the diagonal line, to the length of the first line segment is from 0.9 to 1.1.

12. An electronic/electric device, installed therein the coil component according to claim 1, wherein the coil component is connected to a board via the first terminal member and the second terminal member.
